(19) United States
(12) Patent Application Publication
(10) Pub. No.: US 2016/0374367 A1
(43) Pub. Date: Dec. 29, 2016

(54) SPICE BLEND SALT SUBSTITUTE FOR KETCHUP AND TOMATO BASED FOODS, DESIGNED FOR MARKETING

(71) Applicant: Ken Hantman, Huntingdon Valley, PA (US)

(72) Inventor: Ken Hantman, Huntingdon Valley, PA (US)

(21) Appl. No.: 14/753,167

(22) Filed: Jun. 29, 2015

(51) Int. Cl. A23L 1/237

(52) U.S. Cl. CPC A23L 1/2375; A23L 1/243; A23L 1/237; A23L 1/223; A23L 1/224; A23V 2002/00

(57) ABSTRACT

A natural salt substitute for certain tomato based foods, comprising onion powder and paprika mixed in a particular ratio range resulting in a non-chemical substitute for salt for use with certain tomato based foods. A method for making foods have a salty taste without chemicals. A method for making a very low sodium ketchup with a salty taste with ingredients with no long chemical names.

### CROSS-REFERENCE TO RELATED APPLICATIONS

This application is based on U.S. Provisional Application No. 61/998,804, filed Jul. 9, 2014.

### BACKGROUND OF THE INVENTION

Field of Invention

This invention relates to salt substitute mixtures or blends intended to lower sodium in foods. Classes 426/72; 426/649; and 426/97 were relevant.

Prior Art

Excess salt in diets accounts for 6300 deaths per day worldwide and is associated with one-in-ten deaths in the United States. It also contributes to early onset hypertension and to obesity in children. Even for people with no present hypertension excess salt has deleterious health effects and predisposes the development of hypertension.

Most people eat approximately twice as much salt as the recommended maximum. Most of this comes from salt in foods, predominantly pre-packaged or prepared foods, as opposed to added table salt. Yet 80% of people in a study of 6000 subjects eating this excess amount were unaware of or denied eating excess salt: http://www.unilever.com/sustainable-living/nutrition-health/making-our-products-healthier/reducing-salt. Furthermore the majority of people sampled said that less salt would make their food taste less palatable and they would not want that.

Another thing to recognize is that suggested serving sizes are just not realistic particularly on things like cookies, condiments, potato chips and so forth. People eat several times the suggested serving, so the 300 mg. of sodium becomes 900 mg. in a one or two minute eating experience.

Accordingly various salt substitutes have been patented to offer alternatives to straight sodium chloride, either replacing sodium chloride in whole or in part.

A sampling of prior art with reference to U.S. patents:

| | |
|---|---|
| 6,743,461 | Salt substitute compositions |
| 5,213,838 | Sodium-free salt substitute containing citrates and method for producing the |
| | same |
| 5,207,800 | Low toxicity, biodegradable salt substitute for dyeing textiles: magnesium |
| | acetate in direct or reactive dyeing of cotton |
| 5,094,862 | Salt substitute granule and method of making same |
| 4,963,387 | Salt substitute and foodstuffs containing same |
| 4,734,290 | Process for preparing a coated-particle salt substitute composition |
| 4,560,574 | Salt substitute containing potassium chloride, maltodextrin and sodium |
| | chloride and method of preparation |
| 4,556,578 | NaCl-Free salt substitute containing potassium chloride, maltodextrin and |
| | potassium bitartrate and method of preparation |
| 4,556,577 | Admixture of potassium chloride and maltodextrin as salt substitute and |
| | method of preparation |
| 4,556,568 | Salt substitute containing potassium chloride coated with a mixture |
| | including maltodextrin and potassium bitartrate and method of preparation |
| 4,556,567 | Salt substitute containing potassium chloride coated with maltodextrin and |
| | method of preparation |
| 4,556,566 | Salt substitute containing potassium chloride coated with a mixture of |
| | maltodextrin and sodium chloride and method of preparation |
| 4,473,595 | Low-sodium salt substitute |
| 4,451,494 | Sodium-free salt substitute |
| 4,243,691 | Sodium-free salt substitute |

A review of these shows that the great majority utilize potassium chloride, and in all cases various chemicals. On a scale of 1 to 100, with sodium chloride scoring 100, potassium chloride scores 60 as an index of its perceived “saltiness” taste: http://en.wikipedia.org/wiki/Taste. The addition of 1 ppm thaumatin or the addition of L-lysine or fumaric acid or citric acid helps cut the bitter aftertaste of potassium chloride. Nevertheless, the general reaction of the public to such salt substitutes, garnered from reading reviews of such products on popular retailer Amazon's plentiful user reviews suggests that while reaction is generally positive it is coming from only a medically salt-restricted population, fully aware that they must accept some compromise. Furthermore at least twenty percent of reactions is moderately to highly negative. It must be noted that there are zero reactions saying the substitute is actually superior in taste to plain sodium chloride. There are as well various spice blend substitutes and the reactions to those are about equal to the potassium based ones in terms of perceived flavor as a salt substitute.

While most people don't consume enough potassium it is plentifully available from natural sources. Also some people are on potassium restricted diets as well as sodium restricted, so the best substitute would contain no potassium chloride.

In some of the referenced patents the inventor has conducted what he or she purports to be a panel of subjects to sample the flavor. Although no ill intent or conscious effort to skew or misreport the results is to be imputed, the results are dubious. For one the sample sizes are exceeding small and too small to be statistically significant. Secondly experiments in psychology have shown that experimenter bias is often communicated to subjects by subtle clues of which the experimenter is not consciously aware. In order to have true independence in testing and confidence in the results it is best for an independent company to conduct its own focus groups in a double-blind experiment. Even better is the ultimate test of consumer reaction in the marketplace.

A review of the above cited patented prior art reveals that there are many undoubtedly ingenious chemists and food scientists adept at manipulating molecules but they appear to be oblivious to marketing realties. Their erudition does not extend to considering the consumers' reaction to an ingredient label for, for example ketchup, that would read in whole or in part, for example: “Tomatoes, Water, Vinegar, Sugar, 5′-inosinic acid , 5′-guanosinic acid dipotassium orthophosphate, betaine, magnesium chloride hexahydrate, potassium dihydrogen phosphate, dipotassium succinate, dipotassium malate, proteinogenic L-amino acids, L-alanine, L-valine, L-isoleucine, L-phenylalanine, L-tyrosine, L-glutamic acid, L-asparagine, L-methionine, L-pyroglutamine, L-4-trans-hydroxyproline, L-3-cis-hydroxyproline, L-homocysteine, fumaric acid, thaumatin, fatty acid alkamides, cetylpyridinium chloride, and onion powder.”

Everything between the ingredient tomatoes and the onion powder would be a problem. Most consumers wouldn't want to wash their hair with it if it constituted shampoo, let alone actually eating it. This is simply a marketing reality. Accordingly one of the world's largest food manufacturers, Unilever, sought via its Open Innovation web portal invitations, but to our knowledge did not find, a salt substitute that would not contain potassium chloride or other chemicals.

This is not to say that any of the chemicals in the composed label above, culled from various actual issued patents, are harmful to ingest or even, in some cases, not nutritious. But it is a matter of marketing to consumers. It is a matter of an insurmountable wall of adverse perception. Consumers' fear of chemical-sounding names may be irrational and the professorial designers of these patented substitutes could educate the consumers if they were in their classrooms. But they are not; they are in the supermarket and they will not in large buy such products. The intent to get the general public to cut their excess sodium consumption will not be met if no one buys the products.

Although there is nothing that restricts patents to consumer or commercial use—for example they may involve something for purely scientific or lab use or a process for industrial use—they generally are intended for some form of commercialization and commerce. Because food products are required to bear nutrition labels listing ingredients there is a strong need to make the list sound palatable and to conform to consumers' preference for natural ingredients instead of chemicals and there is a strong preference for known ingredients over unknown ones. Ingredients that are GRAS (Generally Recognized as Safe) is a starting point, with names of natural ingredients that make consumers feel comfortable and not uneasy being the goal.

There are spice blends on the market that combine many spices. Some are marketed as salt substitutes but in fact they taste spicy as opposed to salty. They may taste predominantly like lemon basil or like garlic or a great plethora of spices but none known have tasted like salt. While some salt-restricted consumers accept the substitution, the suggestion that such blends function as substitutes for salt flies in the face of basics of the science of taste perception. In fact tastes of seasonings are relative to the predominant food flavor of the background food.

Mention should be made of a useful patent by Wang et. al., U.S. Pat. No. 8,900,650, Dec. 2, 2014 which nevertheless has a different object than the present one. Wang recognized that in table salt it is only effectively the outer surface of the crystal particle that interacts with the saliva and taste buds. Hence large amounts of sodium are consumed which do not, in this use, contribute to the experience of saltiness. By producing nanometer to micro size particles deposited on a substrate, thus increasing the surface area to mass ratio, greater saltiness results using less overall sodium chloride. However in things such as ketchup or tomato based sauces the sodium chloride has been dissolved and suspended, already achieving the maximum possible surface area to mass ratio. It is not possible to have smaller size than single molecules. Accordingly the present invention addresses not the object of reducing the amount of added table salt to foods but the amount of dissolved sodium chlorides in foods, particularly ketchup and tomato based ones. The same distinction and logic applies to U.S. Pat. No. 7,923,047 of Jensen, et. al., Apr. 12, 2011.

### OBJECTS AND ADVANTAGES

It is impossible to mimic sodium chloride in its universal application to foods including sweet, sour, bitter and umami ones. The present natural salt substitute is intended for use with certain tomato based foods. We have found the best application to ketchup related tomato based products.

In the most preferred embodiment achieving the best results it is applied to tomato ketchup and other tomato sauces.

An object is to provide an excellent salty taste, kick and experience and to enhance the flavor when used in such foods. It would not substitute in foods which have a different predominant flavor such as sweet ones like ice cream or soft drinks. A further object is to provide a definite salt taste and not something else, and yet to bring forth a richer, deeper, fuller and, with analogy to symphonic music, brighter brass section notes of flavor. So an object is to provide a salt substitute that tastes better than straight sodium chloride when applied to the right foods.

An object of the salt substitute described here is to utilize only natural food ingredients and no chemical-sounding ones. The advantage is that in order to truly promote consumer acceptance this is necessary.

A further object is to utilize commonly known food spices which individually or which in any formerly known combination do not simulate the taste of salt and yet in this salt substitute achieve that surprising result. Although these spices are well known to have good tastes whether used singly or in combinations, an object of the present salt substitute is to combine them in a way that suppresses their known flavors and substantially in the specified combination results in the flavor and experience of sodium chloride.

The need to reduce sodium in diets is evident. An object of the present salt substitute is to do this in a way that is palatable and does not encounter consumer resistance. In fact the very description of a product as “Low-Salt” or “Reduced Sodium” is a trigger to most consumers to avoid purchasing it. Further it suggests that the food will taste bland or compromised in terms of ideal flavor. Further the mental suggestion or association will actually influence in a negative way a consumer's taste perception since food is very subject to suggestion. Master chefs call this “presentation and plating” and this is directly or analogously exactly that. So we teach, preferably, to not present a food product with our salt substitute that way but simply to list the ingredients and sodium content on the rear label. An object is to present a substitute that fits with the natural and chemical-free quality sought in foods by manufacturers and consumers.

TV Shows such as the Dr. OZ Show, popular health gurus such as Dr. Andrew Weil, and a plethora of TV personalities and hosts and The American Heart Association are all beating this drum loudly of lowering sodium. It is a wave of the future with a lot of present pressure. The trend is there and growing. An object is to align products with this commercial and public health demand.

Logically, given that salt has a strong taste, if it is added to nearly everything in one's diet it will mask the subtle flavors in foods and their distinguishing, individual flavors. Once salt is gradually reduced these flavors, long covered-over, can open to the more discriminating palate. In the meanwhile there is a need to offer substitutes with greatly lowered sodium chloride but not containing other metal halides. An object is to suit this need.

### SUMMARY

There is a great and pressing need to find a salt substitute that the public will accept. Prior ones have utilized either potassium chloride which has a compromised and inferior taste or chemicals which have names that are frightening to the public and thus not widely saleable. There are natural spice blends but they do not simulate the taste of sodium chloride salt. The object and advantage of the present salt substitute is that it overcomes both these problems although it is limited to application to ketchup and related tomato based foods.

### DESCRIPTION

The natural salt substitute for ketchup and related tomato based foods is comprised of onion and paprika in a ratio of approximately one part onion to three parts paprika, which can be in a range varying from one part onion to two to four parts paprika. The ingredients specified here and below can be in flaked, dried, crushed or powder form. In the preferred embodiment red or Hungarian paprika is used although other varieties of paprika can be used. Quantities specified throughout when stated in fractions of a teaspoon are based on the ingredients in powdered form.

In an alternate preferred embodiment the above can be combined with table salt (sodium chloride) such that there will be approximately 40 mg. of sodium per serving of food to which this is added. This will be equivalent to approximately 10.4 parts of NaCl to onion powder. The amount of sodium chloride added however can be varied in a range from 20 mg. to 80 mg. per serving of food to which it is added.

In an alternative form it is comprised of a combination of garlic, paprika and onion in the approximate ratio of one part garlic to one to two part onions to two to four parts paprika.

In another alternative form any of the above described combinations may have a very small amount of black pepper added of a quantity approximately 1/16^{th} the onion and varying in a range of from half this amount to thrice this amount.

When it is in the form combined with sodium chloride the resulting sodium chloride per serving of food is reduced to from 12% to 50% of the amount typically used in the food product to which it is applied. When a commercially prepared food such as marinara sauce or frozen dinners is particularly high in sodium, the salt substitute of the present invention may reduce the sodium to even as low as, for example, 6% of the prior utilized level. This mixture can in an ideal embodiment replace approximately 75% of the sodium typically added to ketchup, lowering the sodium per serving from the industry standard 160 mg. to about 40 mg.

In another preferred embodiment the salt substitute of the present invention can be combined with tomato paste, water, vinegar and raisins to make a ketchup that is very low in sodium, in the approximate amount of 40 mg. per serving. The sugar results solely from the raisins. Approximately 15 pulverized raisins comprising approximately five grams are utilized per serving. The naturally occurring potassium from the tomatoes and raisins result in approximately 106 mg. of potassium per serving so that an ideal nutritional ratio of sodium to potassium is achieved. This ketchup has no artificial or chemical ingredients, is rich in lycopene and has much lower salt and higher potassium than typical commercial brands presently in use. It has a lower glycemic index and has more antioxidants and micronutrients than typical commercially sold ketchups.

In the above described preferred embodiment an approximate one tablespoon serving of the ketchup is made by combining fifteen pulverized raisins, one-sixteenth teaspoon sodium chloride, one and a half teaspoons of salt free tomato paste, nine-sixteenths teaspoons of white vinegar, fifteen-sixteenths of water, one forty-eighth teaspoon of onion powder, one forty-eighth teaspoon of garlic powder, and one twenty-fourth teaspoon of red paprika. Equivalent quantities in other forms such as dried, flaked or fresh may be substituted for the powdered concentrated forms.

While we don't wish to be bound by a theory of operation, the reason that we believe this salt substitute is limited to certain tomato based foods is that flavor and taste is relative to predominant background flavors. Using the usual analogy of food taste to music, notes played on a fuzz-tone electric guitar that would sound perfectly excellent in a Beatles or Rolling Stones song would sound out-of-place in a classical Spanish guitar composition.

The spices can be in finely ground flakes or crushed or powder form. They are typically thoroughly mixed and uniformly distributed throughout any prepared or prepackaged food. Alternatively they may be applied more to the surface or top of a food than throughout. Alternatively they may be used as a table seasoning to be applied to foods including home-prepared ones.

The spices are simply a mixture and we are not familiar with any chemical reaction. It should be noted that ketchup is made from tomato paste or puree that is already cooked. Again not wishing to be bound by a theory of operation it is our belief that the salt taste that results from the combination can be likened analogously to another known psycho-physical reaction involving sight. Using only black and white colors, for example projected on a black and white TV monitor, given a certain and exact frequency of alternating the black and white, and a given invariant background, colors will virtually appear. Likewise from a black and white Moiré pattern, such virtual color can appear. We believe that analogously, involving the gustatory calyculi and taste perception senses of the brain, that the particular, relatively exact combination of ingredients of the present salt substitute creates a virtual experience of the taste of sodium-chloride in the context of certain food bases. Just as the alternating frequencies of black and white that at a particular ratio and rate cause the virtual color perception must play against a steady background, so the present salt substitute must be used with tomato based foods in order to taste like salt and not have a spice taste. Additionally, to achieve the surprising effect of salt taste the salt substitute must be in a limited range of values of quantity relative to the given food. If too little is used the effect will not occur. If too much is used the effect will not occur and instead the ordinary spice tastes of the components will be evident.

The right quantity results in the preferred embodiment when approximately 0.012 teaspoons of onion powder is combined with approximately 0.024 teaspoons of paprika per food serving, or alternatively combined additionally with 0.0156 teaspoons of salt (NaCl). Alternatively this may be combined with 0.012 to 0.006 teaspoons of garlic powder. Alternatively this can be combined with 0.0004 to 0.002 teaspoons of black pepper. These quantities can vary by 20% more or less from the stated ranges and be in the effective preferred quantities.

Accordingly spices that have been in use for many thousands of years and combined in multiple ways and in innumerable recipes have not in prior art or use been specified in the precise ratios and combination to one another and quantity all together in use relative to the food base quantity to which it is added and which must be restricted to certain tomato based foods and methods of preparation. Despite the search for a natural salt substitute being a long and intensive one, this surprising result from the combination of these very ordinary ingredients was not previously shown. As in an oil painting by a master artist it is discovered that the “magical” effect of light or color that emanates from the canvas was the result of great technical detail, for example mixing the pigments with the right oils, not muddying the color by adding an extraneous one, and by using finer brushes in the ultimate layer than were used in the base layers, so in the present invention the use of ordinary things results in an effect highly dependent on precise specification to achieve the surprising result.

Again, not wishing to be bound by a theory of operation but while it may seem intuitive that a sensory perception of a phenomenon would change in a linear way with the change in intensity or quantity and would not change in quality, there are many instances of analogues in natural science. For example increasing the temperature of ice up to thirty-two degrees Fahrenheit changes nothing in the nature of the ice except its temperature. Then a sudden phase change occurs where it changes to water which has entirely different physical properties which could not have been predicted based on observation of the prior phase state. These qualities persist while temperature rises to the phase change point of two hundred and twelve Fahrenheit. If ice became water in the first change as a result of raising the temperature, it does not become more watery as the temperature is raised nor does it in fact remain water above a certain point. A graph of H₂O through rising temperature and phase state shows that there is no temperature change until a phase transition is complete. It also shows that water exists discretely between two temperatures. In an analogous manner the salt taste from the combination exists only between discrete levels of intensity measurable as a quantity per serving within defined limits relative to a background of certain tomato based foods.

Again, not wishing to be bound to a particular theory but we believe that yet a further explanation of the operation of this invention resulting in an unexpected outcome from a particular combination of previously widely known ingredients is that food or spice flavors are not merely additive but also subtractive. The flavor of any given food, for example of garlic, can be portrayed as at least a five dimensional differential. These dimensions would include sweet, salty, sour, bitter, and umami. Additional dimensions recognized by some food scientists and in some cultures include pungency, coolness, astringency, and fattiness. Although known mechanisms exist for the major tastes, and it is theorized that subclasses of the major categories account for differences in taste it is possible that other mechanisms also exist. Taste (gustation) combined with smell (olfaction) and texture (trigeminal nerve stimulation and mechanoreceptors) generally combine to create our sensation of the food.

So a given food may be portrayed as occupying some portion of a universe comprised of these dimensions, or as extending more or less into each dimension and thus having a particular or differential mapping in the space. While it would be most common to think of tastes as additive, for example something sweet like sugar added to something sour like lemon would be expected to produce a sweet and sour candy, it is also true that some flavors are subtractive. Salt will reduce the perception of bitterness. Lemon is added to fish to counteract very slight or fine elements of putrefaction where the fish is not perfectly fresh. Sugar is added to vinegar to so-called cut the sourness of the vinegar. Although sugar does not significantly alter the pH of the solution or mixture with the vinegar yet it has this effect, proving that taste perception is subjective and not fully described by chemical reactions. This is so because the sourness of vinegar arises from its acidity.

Accordingly, per the theory described, certain tastes or certain components of tastes or perceived extension into the various dimensions of the space defining taste may add or cancel one another, similar to wave phenomena. Thus by analogy this is similar to subtractive color perception. Likewise certain flavors or components of tastes in certain dimensions of the space defining taste may reinforce one another. Accordingly, just as it would be surprising to someone who had never seen the secondary colors to see green emerge from the combination of primary yellow and blue, or to see green result from combining gold and black color, so the emergence of a salty taste from components which individually do not directly or primarily exhibit this taste is of course surprising.

Clearly there is a strong demand to find a non-chemical salt substitute that would have a great taste and no aftertaste. Industry leader Heinz offers a No Salt ketchup as does Hunt's. Both of these contain spices including garlic and onion. Yet in both cases the product is perceived by most as bland tasting, based on many reviews published. The product is intended for those on a medically restricted diet who must accept the compromise of bland taste in exchange for a more healthful product. If these two commercial giants had known the present invention they certainly would have used it to make a better and more appealing product and to improve their other ketchup products by lowering sodium, which is an identified national priority for the food industry. Despite this intensive search and the fact that the components have been in use for thousands of years, the combination of them in the ratio and quantities specified gives the unexpected solution of the problem.

Another way to analogously understand this is to consider that if you are too far or too close to something you cannot see it. Likewise, in the case of this salt substitute, using too little or too much relative to the food serving to which it is applied will not focus the perception on the salty impression.

Insofar as saltiness is directly the perception of sodium ions via ion channels any simulation of saltiness is the taste equivalent of a visual optical illusion. The texture of the powdered garlic and paprika and the additive and subtractive flavor differentials at just the right ratio and quantity relative to a food so treated seem to account for the production of the illusion. However this is highly dependent on the food base to which it is applied. The reasons for this are not presently known. Insofar as taste is also subjective it is not an illusion but a direct experience of saltiness from a mixture which either has no sodium or alkali ions or a very low amount of them.

To fully and clearly describe what the salt substitute is, it is important for us to also explain what it is not. It is not more components or ingredients than those claimed. The unexpected result occurs only when not combined with the addition of other spices. Referring again to the typical analogy of flavor to music, Beethoven's Fifth Symphony starts with a sequence of four notes that are very famous. He interpreted them in words as “Thus Fate knocks at the door.” We have all heard this famous sequence of notes. In hindsight it may seem obvious to us. It certainly seems natural. Someone could say, “I could have written that.” Having heard it, that is true. But in fact it was not obvious until Beethoven's genius brought it forth. It perhaps resonates with something deep in our genetic core. Beethoven did not invent the notes. Those were known. He did not invent the idea of music or the idea of arranging notes and chords in a sequence or combination. It was his particular choosing of those notes in that order, with expressions of loud or soft and fast or slow that created the unique thing that will be remembered in music for all time. Just as Beethoven chose four notes from a range of many notes, a great constellation of notes in which those four happened to occur would not be what he created.

Great chefs, like great musicians, have an advanced sense making them capable of intuiting and then experimenting, testing and perfecting certain combinations. Our salt substitute is just that for a salt substitute limited to a background of certain tomato based foods. If the same ingredients, even if in a similar ratio were included in a combination of many other spices it would not result in the same effect. If the ingredients were used by themselves but in a substantially different ratio than the range specified it would not have the same effect, or would to an increasing degree fall off to a lesser performance of providing a satisfying salt substitute. However if someone desired to flavor a tomato based food with a substitute for sodium chloride and to also give it some other flavor, for example orange extract, or walnut, then the present salt substitute can be utilized and will preserve its integrity and use, while other flavors can be added according to the recipe of any chef. Finally, If the ingredients in the specified ratio were used but in the wrong quantities either too much or too little per food serving, the sense of salty taste would disappear.

### OPERATION OF INVENTION

The mixture described above provides a means to make certain foods taste salty, while using much less sodium chloride salt than typically used. The method is straightforward and involves simply adding the mixture to the food, typically uniformly distributed through a viscous substance such as a sauce or condiment.

Given that the ingredients are in dry form they have a low micro plate count. Their pH falls within a normal range. They have nutritious elements such as vitamin C and have antimicrobial properties.

### CONCLUSION, RAMIFICATION AND SCOPE OF INVENTION

Thus the reader will see that the salt substitute of the invention provides an easy-to-produce, economical and practical solution to the strong market and public health demand to offer a chemical-free substitute to sodium chloride although limited to application to certain tomato based foods.

While our above description contains many specifications these should not be construed as a limitation on the scope of the invention, but rather as an exemplification of one or more preferred embodiments thereof. Many other variants are possible. For example the ingredients can be prepared in a paste form or a fresh form as opposed to dried flakes or powder. Where the base food to which the substitute is applied already contains, whether naturally occurring or by addition, one of the specified ingredients the mixture can be prepared reducing or eliminating that ingredient so long as the resulting food serving overall preserves roughly the specified ratio of ingredients.

Variations from the preferred embodiment may involve substitution of variants such as white pepper for black pepper. Ingredients may be added cold or hot.

Accordingly, the scope of the invention should be determined not by the embodiment(s) but by the appended claims and their legal equivalents.

1. A natural salt substitute for certain tomato based foods, comprising:
(a) onion powder,
(b) paprika,
(c) said members mixed together in a ratio of one part onion to two to four parts paprika, whereby a non-chemical substitute for salt for use with certain tomato based foods will be provided.

2. The salt substitute of claim 1 wherein the quantity of the substitute will be 0.025 to 0.075 teaspoons per one serving size of a food to which said substitute is applied.

3. The salt substitute of claim 1 wherein black pepper is added in a ratio of one-thirty-second part to one-eighth part black pepper to one part onion to two to four parts paprika.

4. The salt substitute of claim 3 wherein the quantity of the substitute will be approximately 0.025 to 0.075 teaspoons per one serving size of a food to which said substitute is applied.

5. The salt substitute of claim 3 wherein sodium chloride is added in a ratio of from five to twenty parts of sodium chloride to one part of onion to two to four parts of paprika to one-thirty-second part to one-eighth part black pepper.

6. The salt substitute of claim 1 wherein garlic powder is added in a ratio of one-half to one part of said onion powder and wherein the said onion powder has a ratio of one part to two to four parts of said paprika.

7. The salt substitute of claim 6 wherein the quantity of the substitute will be approximately 0.025 to 0.075 teaspoons per one serving size of a food to which said substitute is applied.

8. The salt substitute of claim 6 wherein sodium chloride is added in a ratio of from five to twenty parts of sodium chloride to one part of onion to two to four parts of paprika to one-half to one part garlic.

9. The salt substitute of claim 1 wherein sodium chloride is added in a ratio of from five to twenty parts of sodium chloride to one part of onion to two to four parts of paprika to one-half to one part garlic.

10. A method for making foods have a salty taste without salts or chemicals being added or with greatly reduced amounts of salts being added, comprising the steps of:
a. combining onion powder or flaked, dried or fresh onion with paprika in an approximate ratio of one part onion to two to four parts of paprika, and
b. adding the combined onion and paprika to certain tomato based foods, whereby said foods will be made to have a salty taste.

11. The method of claim 10 in which additional steps are added comprising measuring a quantity of approximately 0.025 to 0.075 teaspoons of the combined ingredients and applying it to one serving size of said certain tomato based food to which it is applied.

12. The method of claim 10 in which an additional step is added comprising adding garlic in a ratio of one-half to one part garlic to one part onion to two to four parts paprika.

13. The method of claim 10 in which an additional step is added comprising adding black pepper in a ratio of one-thirty-second to one-eighth part black pepper to one part onion to two to four parts of paprika.

14. The method of claim 10 in which an additional step is added comprising adding sodium chloride in a ratio of from five to twenty parts of sodium chloride to one part of onion to two to four parts of paprika.

15. A method of making a low sodium ketchup with a salty taste using approximately one-quarter the typical levels of sodium in commercially produced ketchups and without ingredients with long chemical names, comprising:
(a) adding two parts raisins, and
(b) pulverizing said raisins into a paste, and
(c) adding one and a half parts tomato paste, and
(d) adding nine-sixteenths parts of white vinegar, and
(e) adding fifteen-sixteenths parts of water, and
(f) adding one-sixteenth part sodium chloride, and
(g) adding one forty-eighth part onion powder, and
(h) adding one forty-eighth part garlic power, and
(i) adding one twenty-fourth part paprika, and
(j) mixing and blending together said parts.

16. The method of claim 15 wherein the quantity of any of the ingredients is in a range of fifty percent more than the stated amount to fifty percent less than the stated amount

17. The method of claim 15 wherein an additional step is added comprising adding black pepper in the range of one-sixtieth to one-hundred-and-eightieth parts.
